(19) United States
(12) Patent Application Publication
(10) Pub. No.: US 2004/0124276 A1
(43) Pub. Date: Jul. 1, 2004

(54) Fuel injection valve

(76) Inventors: Werner Berger, Markgroeningen (DE); Martin Buehner, Backnang (DE)

Correspondence Address: KENYON & KENYON, ONE BROADWAY, NEW YORK, NY, 10004, US

(21) Appl. No.: 10/469,451

(22) PCT Filed: Nov. 29, 2002
(86) PCT No.: PCT/DE02/04385

(30) Foreign Application Priority Data
Jan. 3, 2002 (DE) 102 00 044.1

(51) Int. Cl. F02M 59/00

(52) U.S. Cl. 239/533.2

(57) ABSTRACT

A fuel injector (1) for the direct injection of fuel into the combustion chamber (18) of a mixture-compressing, spark-ignition internal combustion engine includes a nozzle body (2) and a sealing ring (15) which seals off the fuel injector (1) from a cylinder head (11) of the internal combustion engine. An adhesion-reducing coating (17) is provided in an annular gap (14) formed between a wall (13) of the cylinder head (11) and the nozzle body (2) of the fuel injector (1).

### BACKGROUND INFORMATION

The present invention relates to a fuel injector of the type set forth in the main claim.

From German patent application 196 00 403 A1, an electromagnetic fuel injector and a mounting structure for it are known, for example, which satisfy the requirements with regard to sealing effect, thermal resistance, and pressure resistance for an internal combustion engine having a cylinder injection system. Particular attention is paid, in this context, to sealing the area in the immediate vicinity of the cylinder in which the electromagnetic fuel injector is mounted, as well as to an area that is more distant therefrom. As a result, according to the present invention, a first sealing section, having a first sealing ring that is configured as a corrugated supporting ring (wavy washer), is situated near the cylinder and between the fuel injector and the cylinder head. In addition, a second sealing section, having a second sealing ring that is also configured as a corrugated supporting ring, is positioned further away from the cylinder than the first sealing section.

One disadvantage in particular, of the fuel injector known from German patent application 196 00 403 A1 is its high susceptibility to carbonization occurring downstream of the sealing ring in the gap that is formed between the fuel injector and the wall of the cylinder head. The result is that substantial force is needed when disassembling the fuel injector from the cylinder head, so that damage can occur.

In another respect, the thermal stress on the sealing ring across the annular gap is considerable when the internal combustion engine is started up, and it can lead to the destruction of the sealing ring and to subsequent failures.

### ADVANTAGES OF THE INVENTION

In contrast, the fuel injector according to the present invention having the characterizing features of the main claim has the advantage that a coating that is applied to the tip of the fuel injector and that fills the annular gap between the fuel injector and the cylinder wall prevents fuel from penetrating and subsequently combusting in the annular gap. This makes it possible, on the one hand, to prevent carbonization deposits from forming in the annular gap and, on the other hand, to reduce the thermal stress on the sealing ring.

As a result of the measures indicated in the subclaims, advantageous refinements of the fuel injector indicated in the main claim are possible.

It is especially advantageous that the coating may be solid, pasty, or liquid, depending on the demands that are placed on it.

In the case of solid coatings, the entire space should not be filled, because, otherwise, it is not possible to compensate for installation tolerances (e.g., in tilting the injector).

The coating advantageously fills the entire downstream part of the annular gap, so that no penetration of the mixture is permitted.

It is also of particular advantage that the coating is able to be realized in the form of a thin Teflon® layer, which may be formed as an integral part of the sealing ring, also made of Teflon®.

### BRIEF DESCRIPTION OF THE DRAWING

An exemplary embodiment of the present invention is explained in greater detail in the following description and is depicted in simplified form in the drawing, whose:

FIG. 1 depicts a schematic sectional view of an exemplary embodiment of a fuel injector according to the present invention.

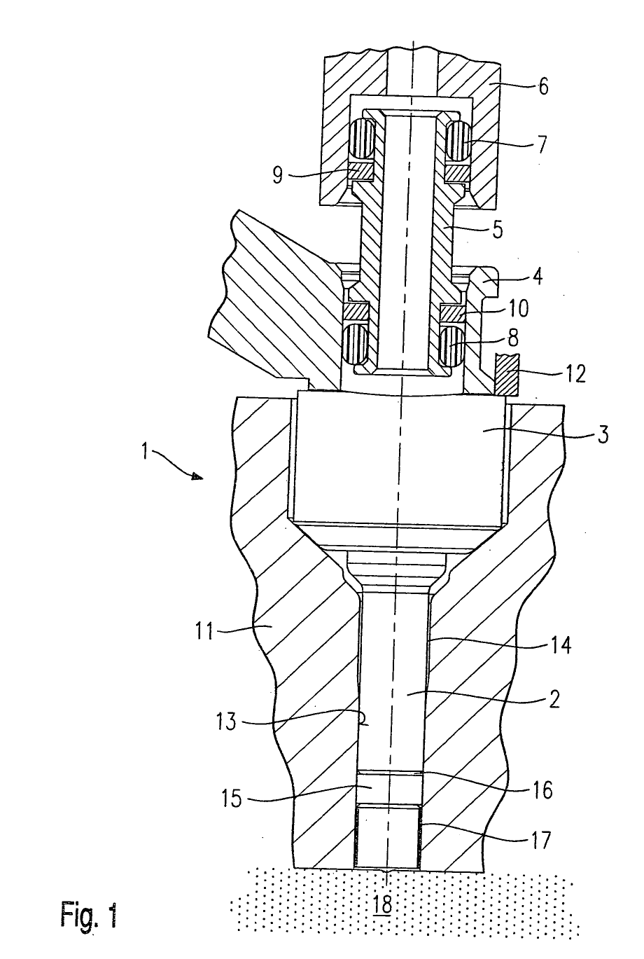

### DESCRIPTION OF THE EXEMPLARY EMBODIMENT

A fuel injector 1 is designed in the form of a fuel injector for injection systems of mixture-compressing, spark-ignition internal combustion engines. Fuel injector 1 is well suited for the direct injection of fuel into a combustion chamber 18 of an internal combustion engine.

Fuel injector 1 includes a nozzle body 2 and a valve housing 3. On the intake side is an intake connecting pipe 4, in which an intermediate sleeve 5 is disposed for joining fuel injector 1 to a fuel distribution line 6. The seal between fuel injector 1 and intermediate sleeve 5, as well as between intermediate sleeve 5 and fuel distribution line 6 is effected by sealing rings 7 and 8. Support members 9 and 10 assure that the above-mentioned component parts will have the correct mounting position in relation to each other.

Fuel injector 1 is inserted into a cylinder head 11 of the internal combustion engine and is secured there in a fixed and non-rotatable fashion by a holding clamp 12, depicted only schematically, which can be configured, e.g., as a clamping shoe or spring cage.

Formed between a wall 13 of cylinder head 11 is an annular gap 14, which must have a specific width to enable, on the one hand, fuel injector 1 to be installed without excessive application of force, thereby ensuring that fuel injector 1 is not damaged, and which, on the other hand, permits the thermal expansion of the component parts when they are heated by the operation of the internal combustion engine.

To seal off cylinder head 11 from the combustion chamber, a sealing ring 15 is provided, which is disposed in a recess 16 in nozzle body 2 of fuel injector 1. Sealing ring 15 is preferably made of Teflon®, to achieve a reliable sealing effect while providing a high degree of stability.

Downstream of sealing ring 15, annular gap 14 in accordance with the present invention is filled by a coating 17, which prevents the air-fuel mixture from penetrating into annular gap 14 and combusting after the ignition of the mixture cloud in combustion chamber 18, thus leaving carbonization deposits. In the case of solid coatings, the entire space should not be filled, because otherwise installation tolerances could not be compensated for (e.g., in tilting the fuel injector). If fuel injector 1 is removed from cylinder head 11 in the absence of coating 17 according to the present invention, this becomes considerably more difficult as a result of the caked-on carbonization deposits, which can result in damage either to fuel injector 1, including potentially its complete destruction, or to walls 13 of cylinder head 11.

In addition, coating 17 reduces the excessive thermal stressing of sealing ring 15, which occurs when the internal combustion engine is started up. Coating 17 must, therefore, preferably be temperature-resistant up to 200° C. as well as resistant to the atmosphere in the combustion chamber, so that any potential contact between the mixtures present in combustion chamber 18 and the material of coating 17 does not have a destructive effect.

In this context, coating 17 can be applied either before installation onto either nozzle body 2 of fuel injector 1 or wall 13 of cylinder head, or it can be applied to annular gap 14 after the installation of the fuel injector. Coating 17 can, therefore, be either solid or pasty, brushable or liquid. For example, it may be extruded into annular gap 14 from a tube or similar device.

The coating may be made of a thin Teflon® layer, for example. It may also be formed as an integral part of sealing ring 15, which is also made of Teflon®.

In this context, coating 17 is applied to the downstream end of nozzle body 2 of fuel injector 1 in such a way that it completely covers the part of annular gap 14 extending on the downstream side of sealing ring 15 over the entire axial length between sealing ring 15 and combustion chamber 18. This prevents any penetration of mixture into annular gap 14.

The present invention is not limited to the exemplary embodiment depicted and is applicable to any type of design of fuel injectors 1, such as for fuel injectors 1 that are integrated in a common rail system.

What is claimed is:

1. A fuel injector (1), especially for the direct injection of fuel into the combustion chamber (18) of a mixture-compressing, spark-ignition internal combustion engine, comprising a nozzle body (2) and a sealing ring (15) which seals off the nozzle body (2) from a cylinder head (11) of the internal combustion engine,
wherein an adhesion-reducing coating (17) is provided at least on the side of the sealing ring (15) that faces the combustion chamber (18) in an annular gap (14) that is formed between a wall (13) of the cylinder head (11) and the nozzle body (2) of the fuel injector (1).

2. The fuel injector as recited in claim 1,
wherein the coating (17) is only placed on the downstream-side of the sealing ring (15).

3. The fuel injector as recited in claim 2,
wherein the coating (17) extends over the entire axial length of the annular gap (14) between the sealing ring (15) and the combustion chamber (18).

4. The fuel injector as recited in one of claims 1 through 3,
wherein the coating (17) has a solid consistency.

5. The fuel injector as recited in claim 4,
wherein the coating (17) is made of a thin Teflon® layer.

6. The fuel injector as recited in one of claims 1 through 5,
wherein the coating is formed as an integral part of sealing ring (15).

7. The fuel injector as recited in one of claims 1 through 3,
wherein the coating (17) has a pasty or liquid consistency.

8. The fuel injector as recited in one of claims 1 through 7,
wherein the coating (17) is temperature-resistant up to at least 200° C.
